(19) United States
(12) Patent Application Publication
(10) Pub. No.: US 2026/0143212 A1
(43) Pub. Date: May 21, 2026

(54) CAMERA MODULE

(71) Applicant: SAMSUNG ELECTRO-MECHANICS CO., LTD., Suwon-si (KR)

(72) Inventor: Kyungmin SEO, Suwon-si (KR)

(73) Assignee: SAMSUNG ELECTRO-MECHANICS CO., LTD., Suwon-si (KR)

(21) Appl. No.: 19/285,504

(22) Filed: Jul. 30, 2025

(30) Foreign Application Priority Data
Nov. 15, 2024 (KR) 10-2024-0163015

(51) Int. Cl. H04N 23/51; H04N 23/54

(52) U.S. Cl. CPC H04N 23/51; H04N 23/54

(57) ABSTRACT

A camera module includes an optical filter; a substrate on which an image sensor is mounted; and a sub-housing, in which the optical filter is disposed, including a main frame, a base portion extending toward the substrate from the main frame and contacting the substrate, and a protrusion protruding from the base portion. The protrusion includes a first portion protruding toward an inner side of the sub-housing from the base portion and having a height forming a first gap from the substrate, and a second portion protruding toward the inner side of the sub-housing from the first portion and having another height forming a second gap from the substrate that is narrower than the first gap.

### CROSS-REFERENCE TO RELATED APPLICATIONS

This application claims the benefit under 35 USC 119(a) of Korean Patent Application No. 10-2024-0163015 filed on Nov. 15, 2024, in the Korean Intellectual Property Office, the entire disclosure of which is incorporated herein by reference for all purposes.

### BACKGROUND

### 1. Field

The present disclosure relates to a camera module.

### 2. Description of the Background

Optical filters included in camera modules are assembled in various ways. The optical filter may be attached to a driving device or a sub-housing, and in some instances, it may be assembled to a lowermost end of a lens. Currently, many optical filters are assembled into the camera modules by being attached to the sub-housings. This is because it is the most advantageous in terms of unit prices or management. The sub-housing is received on a circuit board on which an image sensor is mounted. However, regarding the above-noted manufacturing method, when force is applied to a bottom of a circuit board during assembly, the circuit board may be bent between empty spaces in the sub-housing, causing the mounted image sensor to be also bent, and resulting in a defect.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes an optical filter; a substrate on which an image sensor is mounted; and a sub-housing, in which the optical filter is disposed, including a main frame, a base portion extending toward the substrate from the main frame and contacting the substrate, and a protrusion protruding from the base portion. The protrusion includes a first portion protruding toward an inner side of the sub-housing from the base portion and having a height forming a first gap from the substrate, and a second portion protruding toward the inner side of the sub-housing from the first portion and having another height forming a second gap from the substrate that is narrower than the first gap.

The protrusion may be spaced apart from the substrate.

The protrusion may extend toward a hollow space of the sub-housing from the base portion.

The second gap may be equal to or less than 0.02 mm.

The first gap may be equal to or greater than 0.09 mm.

The protrusion may include at least two protrusions.

The second portion may be longer than the first portion.

In another general aspect, a camera module includes an optical filter; a substrate on which an image sensor is mounted; and a sub-housing, accommodating the optical filter, including a main frame, a base portion extending toward the substrate from the main frame and contacting the substrate, and a protrusion protruding from the base portion. The protrusion includes a step portion with an uneven rise protruding toward an inner side of the sub-housing from the base portion.

The protrusion may be spaced apart from the substrate.

The protrusion may include a first portion protruding toward the inner side of the sub-housing from the base portion and having a height forming a first gap from the substrate, and a second portion protruding toward the inner side of the sub-housing from the first portion and having another height forming a second gap from the substrate that is narrower than the first gap.

The second gap may be equal to or less than 0.02 mm.

The first gap may be equal to or greater than 0.09 mm.

Other features and aspects will be apparent from the following detailed description, the drawings, and the claims.

### BRIEF DESCRIPTION OF DRAWINGS

FIG. 1 shows a perspective view of an external shape of a camera module according to an embodiment.

FIG. 2 shows an exploded perspective view on a camera module shown in FIG. 1.

FIG. 3 shows an enlarged perspective view of a sub-housing of a camera module shown in FIG. 2.

FIG. 4 shows a perspective view of a rear surface of a sub-housing shown in FIG. 3.

FIG. 5 shows a cross-sectional view of a portion of a sub-housing of FIG. 4 received on a first substrate.

FIG. 6 shows a rear surface of a sub-housing according to another embodiment.

FIG. 7 shows a portion A of FIG. 6.

FIG. 8 shows a portion of a sub-housing of FIG. 6 received on a first substrate.

FIG. 9 shows an effect of suppressing the bending of a substrate according to the present embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Various embodiments and variations will now be described with reference to accompanying drawings. A height described below means a distance defined in an optical-axis direction from a reference point, and the height needs to be understood as being different from a thickness. A description of the height may mean a relative disposed based on an optical-axis direction (a z-axis direction in the drawings). That is, the description “A is higher than B’ needs to be understood as meaning that A is disposed to be closer to a light incidence direction than B to the light incidence direction.

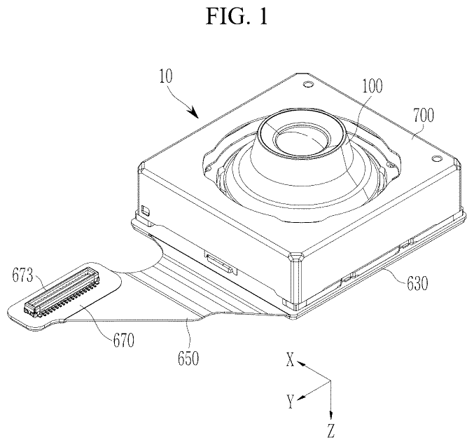

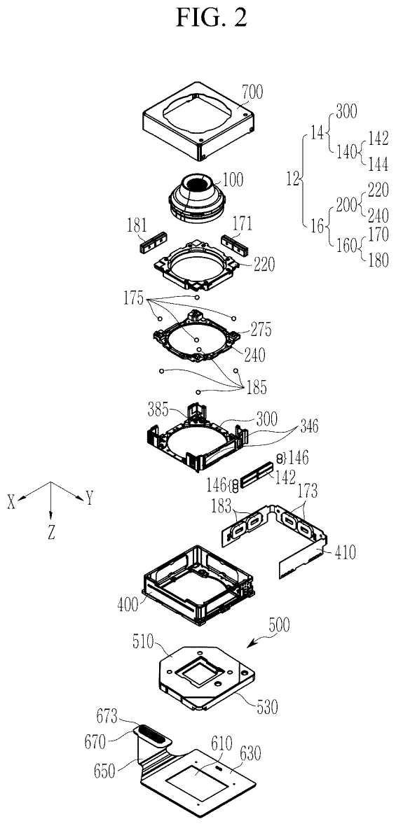

FIG. 1 shows a perspective view of an external shape of a camera module according to an embodiment. FIG. 2 shows an exploded perspective view of a camera module shown in FIG. 1.

Referring to FIG. 1 and FIG. 2, the camera module 10 according to the present embodiment includes a lens barrel 100, a lens driving device 12 for moving the lens barrel 100, an image sensor 610 for converting light input through the lens barrel 100 into an electrical signal, a first substrate 630 mounted on the image sensor 610, and a sub-housing 500 disposed on a substrate portion. The lens barrel 100, the lens driving device 12, and the sub-housing 500 are received in a housing 400. The housing 400 may be covered by a cover 700.

One or more lenses for photographing a subject may be mounted on the lens barrel 100. The lens barrel 100 may have a hollow space in a cylindrical shape, and may receive one or more lenses. A desired number of lenses may be arranged in the lens barrel 100 according to the design of the lens barrel 100.

When the lenses are arranged, the lenses may respectively have optical characteristics. For example, the respective lenses may have different refractive indices. Some of the lenses may have the same refractive index. An optical axis may be set to describe the present embodiment. The optical axis may be set as a central axis of the lens received in the lens barrel 100. The optical-axis direction represents a direction that is parallel to the center axis of the lens. The optical axis is set as a Z-axis. An X-axis and a Y-axis are set in the perpendicular direction to the optical axis. The Z-axis may be set as a direction in which light input through the lens proceeds in the camera module 10. For example, the optical-axis direction may face the first substrate 630 from the housing 400. For better understanding and ease of description, the direction in which an arrow on the Z-axis will be set as up, and the opposite direction will be set as down in the drawing. That is, light input to the camera module 10 moves from top to bottom in the optical-axis direction. In the drawing, a planar direction is defined as a planar direction that is perpendicular to the optical-axis direction. The planar direction is set by a first direction and a second direction. The first direction and the second direction are perpendicular to the optical-axis direction and are perpendicular to each other. The first direction is set as the X-axis direction, and the second direction is set as the Y-axis direction.

The lens barrel 100 may be received in the lens holder 220, and the lens holder 220 may be received in a carrier 300. The lens holder 220 includes a center opening into which the lens barrel 100 is inserted. The lens barrel 100 is combined with the lens holder 220 through the center opening and is affixed thereto. The lens holder 220 and the carrier 300 may be received in the housing 400. For example, the lens holder 220 may have a frame shape with four corners. The housing 400 may have a frame shape with a center opening and four corners. The center opening of the lens holder 220 and the center opening of the housing 400 may be arranged in the optical-axis direction.

For example, the lens holder 220 may be relatively moved in the first direction and the second direction with respect to the carrier 300. The carrier 300 may be relatively moved in the optical-axis direction with respect to the housing 400. The lens holder 220 and the carrier 300 may be moved by the lens driving device 12.

The lens driving device 12 moves the lens barrel 100. The lens driving device 12 includes an auto focus (AF) unit 14 and an optical image stabilization (OIS) unit 16. The AF unit 14 may move the lens barrel 100 in the optical-axis direction. The OIS unit 16 may move the lens barrel 100 in the direction (the X-axis direction or the Y-axis direction) that is perpendicular to the optical axis. For example, the lens driving device 12 may use the AF unit 14 and may move the lens barrel 100 in the optical-axis direction to adjust the focus or realize a zoom function. The lens driving device 12 may use the OIS unit 16 and may move the lens barrel 100 in the direction (the X-axis direction or the Y-axis direction) that is perpendicular to the optical axis to thus correct a vibration when photographing images.

The AF unit 14 may include the carrier 300 and the AF driver 140. The carrier 300 may receive the lens barrel 100. The AF driver 140 may provide a driving force by which the carrier 300 having received the lens barrel 100 moves in the optical-axis direction. The AF driver 140 may include an AF driving magnet 142 and an AF driving coil 144.

When a power voltage is applied to the AF driving coil 144, an electromagnetic influence may be generated between the AF driving magnet 142 and the AF driving coil 144. Hence, the carrier 300 may move in the optical-axis direction. As the carrier 300 receives the lens barrel 100, the lens barrel 100 may move in the optical-axis direction by the movement of the carrier 300. Therefore, the focus may be adjusted.

A first rolling member 146 may be arranged between the carrier 300 and the housing 400. The first rolling member 146 may, when the carrier 300 moves in the optical-axis direction, reduce friction between the carrier 300 and the housing 400. The first rolling member 146 may have a ball shape.

A first guide groove 346 for receiving the first rolling member 146 may be disposed in the carrier 300. The first rolling member 146 may include multiple first rolling members that are arranged in parallel in the optical-axis direction in the first guide groove 346. The first rolling member 146 when formed in plural may have different sizes. For example, in the first guide groove 346, the first rolling member 146 disposed at the top and the bottom may be bigger than the first rolling member 146 disposed therebetween.

The first guide groove 346 may be formed in multiples. For example, when the first guide groove 346 are in multiples, two of the first rolling member 146 may be arranged in one first guide groove 346, and three of the first rolling member 146 may be arranged in the other first guide groove 346.

The carrier 300 may have a frame shape with four lateral surfaces. The first guide groove 346 may be disposed on a corner portion of the carrier 300 in a frame shape. For example, the first guide groove 346 may be arranged at corners on both sides of the lateral surface on which the AF driving magnet 142 is disposed from among the four lateral surfaces of the carrier 300.

The OIS unit 16 may correct motion blur of images or shakes of videos caused by factors such as hand vibration of a user when photographing images or videos. The OIS unit 16 may, when a vibration is generated while photographing images, provide a relative displacement corresponding to the vibration to the lens barrel 100 to thus compensate for the vibration. For example, the OIS unit 16 may move the lens barrel 100 in the first direction and the second direction to correct the vibration.

The OIS unit 16 includes a guide member 200 for guiding a movement of the lens barrel 100 and an OIS driver 160 for providing a driving force to the guide member 200. The guide member 200 may move in the direction that is perpendicular to the optical-axis direction by the driving force provided by the OIS driver 160.

The guide member 200 includes a lens holder 220 and a support frame 240. The lens holder 220 and the support frame 240 may be arranged in the optical-axis direction and may be received in the carrier 300. The lens holder 220 and the support frame 240 may be interlocked to each other and may guide the movement of the lens barrel 100. The lens holder 220 and the support frame 240 respectively have a center opening into which the lens barrel 100 is inserted. The lens barrel 100 may be combined with the lens holder 220 through the center opening and may be affixed thereto. For example, the lens holder 220 may have a frame shape with four corners, and the support frame 240 may have a frame shape that corresponds to the shape of the lens holder 220.

The OIS driver 160 includes a first OIS driver 170 and a second OIS driver 180. The first OIS driver 170 generates a driving force in the first direction that is perpendicular to the optical-axis direction, and the second OIS driver 180 generates a driving force in the second direction that is perpendicular to the optical-axis direction and first direction. The first OIS driver 170 includes a first OIS driving magnet 171 and a first OIS driving coil 173, and the second OIS driver 180 includes a second OIS driving magnet 181 and a second OIS driving coil 183.

The first OIS driving magnet 171 and the second OIS driving magnet 181 may be mounted on the lens holder 220. The first OIS driving coil 173 and the second OIS driving coil 183 may be arranged in the housing 400. The first OIS driving coil 173 and the second OIS driving coil 183 may be mounted on the second substrate 410 and may be arranged in the housing 400 with the second circuit board as a medium. The first OIS driving magnet 171 and the first OIS driving coil 173 are arranged to face each other. The second OIS driving magnet 181 and the second OIS driving coil 183 are arranged to face each other.

The second substrate 410 may be combined with the housing 400. The second substrate 410 may be a circuit board on which wire patterns are printed such as a flexible printed circuit board or a rigid flexible printed circuit board. For example, the second substrate 410 may be bent twice. For example, when the housing 400 has a frame shape with four lateral surfaces, the second substrate 410 may cover three of the four lateral surfaces of the housing 400.

A second rolling member 175 may be arranged between the lens holder 220 and the support frame 240. The second rolling member 175 may maintain a gap between the lens holder 220 and the support frame 240. The second rolling member 175 may guide the movement of the lens holder 220. A second guide groove 275 may be formed on a surface on which the lens holder 220 faces the support frame 240 in the optical-axis direction. The second rolling member 175 may be received in the second guide groove 275 and may be inserted between the lens holder 220 and the support frame 240. The lens holder 220 may, while supported by the second rolling member 175 received in the second guide groove 275, have a limit in moving in the optical-axis direction and the second direction, and may move in the first direction. By the movement of the lens holder 220, the lens barrel 100 may have a limit in the movement in the optical-axis direction and the second direction, and may move in the first direction.

A third rolling member 185 may be arranged between the support frame 240 and the carrier 300. The third rolling member 185 may maintain the gap between the support frame 240 and the carrier 300. The third rolling member 185 may guide the movement of the support frame 240. A third guide groove 385 may be formed on a surface on which the support frame 240 faces the carrier 300 in the optical-axis direction. The third rolling member 185 may be received in the third guide groove 385 and may be inserted between the support frame 240 and the carrier 300. The support frame 240 may, while supported by the third rolling member 185 received in the third guide groove 385, may have a limit in movement in the optical-axis direction and the first direction, and may move in the second direction. By the movement of the support frame 240, the lens barrel 100 may have a limit in movement in the optical-axis direction and the first direction, and may move in the second direction.

The lens barrel 100 and the lens driving device 12 are received in an internal space of the housing 400. For example, the housing 400 may have a box shape of which an upper portion and a lower portion are opened. The image sensor 610 may be disposed on the lower portion of the housing 400.

The image sensor 610 converts light input through the lens barrel 100 into an electrical signal. The image sensor 610 may be disposed below the lens barrel 100 in the optical-axis direction. The image sensor 610 may be installed on the first substrate 630. The image sensor 610 may be electrically connected to the first substrate 630. For example, the image sensor 610 may be one of a charge coupled device (CCD), a metal oxide semiconductor (MOS), and a charge injection device (CPD), but is not limited thereto. The electrical signal converted by the image sensor 610 is output as an image through a display unit of an electronic device.

The electrical signal generated by the image sensor 610 may be transmitted to the first substrate 630. The first substrate 630 may include a circuit board on which electrically connected wire patterns are printed such as a rigid printed circuit board, a flexible printed circuit board, or a rigid flexible printed circuit board.

The camera module 10 may include a connector 670 and a connecting substrate 650. The connector 670 may be electrically connected to the first substrate 630. The connector 670 may include a port 673 electrically connected to an external device. The connecting substrate 650 may electrically connect the first substrate 630 and the connector 670. The connecting substrate 650 may include a flexible printed circuit board.

The cover 700 may be combined with the housing 400 to wrap an external surface of the housing 400. The cover 700 may have a box shape in which a lower portion is opened and has four lateral surfaces. The cover 700 protects the internal parts of the camera module 10. The cover 700 may be made of a plate of a metal material, and may be made of a material with a corrosion rate such as stainless. The cover 700 may shield electromagnetic waves. For example, the cover 700 may shield the electromagnetic waves so that the electromagnetic waves generated by the camera module 10 may not influence other electronic parts in the electronic device. The cover 700 may be combined with the first substrate 630 and may provide a ground. The cover 700 may have a center opening. The center opening of the lens holder 220, the center opening of the housing 400, and the center opening of the cover 700 may be arranged in the optical-axis direction.

The sub-housing 500 may be disposed between the lens barrel 100 and the first substrate 630. A hollow space 521 may extend through surfaces at a center portion of the sub-housing 500. The hollow space 521 of the sub-housing 500 may overlap the image sensor 610 in the optical-axis direction. The hollow space 521 of the sub-housing 500 may have a planar quadrangular shape.

The optical filter 590 may be mounted on the sub-housing 500. The optical filter 590 may be arranged to block the hollow space 521 of the sub-housing 500. The optical filter 590 may overlap the image sensor 610. The optical filter 590 may block light with a specific frequency bandwidth from among the light passing through the lens from being input to the image sensor 610. The optical filter 590 may be arranged in the planar direction (or an X-Y-axis planar direction). The optical filter 590 may include an infrared ray cut-off filter. The optical filter 590 may be affixed to the sub-housing 500 by various methods. For example, the optical filter 590 may be adhered and affixed to the sub-housing 500 by using an ultraviolet ray-curing adhesive material or a heat-curing adhesive material. The adhesive material may include an epoxy material. For another example, the optical filter 590 may be adhered and affixed to the sub-housing 500 using an adhesive tape.

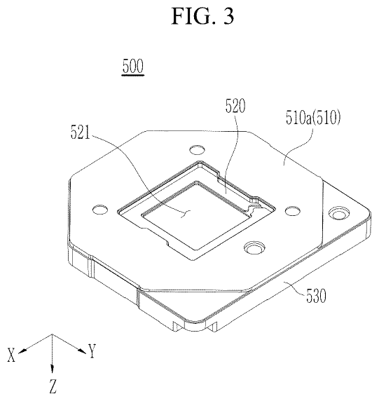

A sub-housing of a camera module according to the present embodiment will now be described in detail with reference to FIG. 3 to FIG. 5 together with FIG. 2.

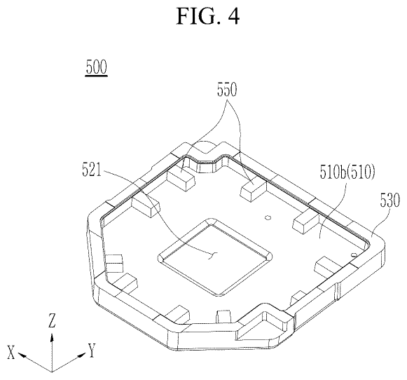

FIG. 3 shows an enlarged perspective view of a sub-housing of a camera module shown in FIG. 2. FIG. 4 shows a perspective view of a rear surface of a sub-housing shown in FIG. 3.

Referring to FIG. 2, FIG. 3, and FIG. 4, the sub-housing 500 includes a main frame 510, a receiving portion 520 in which an optical filter 590 is arranged, a base portion 530 combined to a first substrate 630, and a protrusion 550 extending from the base portion 530. A hollow space 521 is formed on the center portion of the sub-housing 500, and the receiving portion 520 is disposed to surround the hollow space 521.

The main frame 510 may have various forms. For example, as shown in FIG. 2 and FIG. 3, the main frame 510 may substantially have a pentagonal form or a quadrangular form. However, the form of the main frame 510 is not limited thereto. The main frame 510 includes a first surface 510a facing the lens barrel 100 and a second surface 510b facing the first substrate 630.

A hollow space 521 is formed on a center portion of the main frame 510. The hollow space 521 penetrates the main frame 510 in the optical-axis direction. The hollow space 521 may be closed by an optical filter. The image sensor 610 may be disposed below the hollow space 521. Light having passed through the lens barrel 100 may pass through the hollow space 521 of the sub-housing 500 and may be transmitted to the image sensor 610.

The receiving portion 520 may be disposed on an edge of the hollow space 521. The receiving portion 520 may have a step on the first surface 510a. The receiving portion 520 may be dented from the hollow space 521 and the first surface 510a with a predetermined depth in the downward optical-axis direction. The depth of the receiving portion 520 in the optical-axis direction may be equal to or greater than a thickness of the optical filter. Therefore, when the optical filter is arranged on the receiving portion 520, the optical filter may be disposed on the same plane as the upper portion, or may be disposed below the upper surface in the optical-axis direction.

The base portion 530 represents a portion where the sub-housing 500 is combined with the first substrate 630. The base portion 530 contacts the first substrate 630. The base portion 530 may extend downward from an edge of the main frame 510 in the optical-axis direction. The base portion 530 may extend to the first substrate 630 from the edge of the main frame 510. However, the entire base portion 530 may not correspond to the edge of the main frame 510, and may partly formed further inside than the edge of the main frame 510. The base portion 530 may be formed on the edge of a lower portion. A height of the base portion 530 in the optical-axis direction may be formed to be greater than the depth of the receiving portion 520. The base portion 530 may be combined with the first substrate 630 using an adhesive means such as an adhesive agent or an adhesive tape.

The protrusion 550 protrudes toward the inside of the sub-housing 500 from the base portion 530. The protrusion 550 may extend to a center of the sub-housing 500 from the base portion 530. The protrusion 550 extends to the hollow space 521 from the base portion 530 along the second surface 510b. From another viewpoint, the protrusion 550 may extend downward from the second surface 510b in the optical-axis direction. That is, the protrusion 550 may extend toward the first substrate 630 from the second surface 510b. The protrusion 550 may be disposed on the second surface 510b. The length of the protrusion 550 extending downward from the second surface 510b in the optical-axis direction, that is, the height of the protrusion 550 is less than the height of the base portion 530. Therefore, the protrusion 550 may not contact the first substrate 630, and a predetermined gap may be formed between the protrusion 550 and the first substrate 630. Hence, the protrusion 550 may be spaced apart from the first substrate 630. Multiple protrusions 550 may be provided. The length of the protrusion 550 measured in the planar direction is not specifically limited.

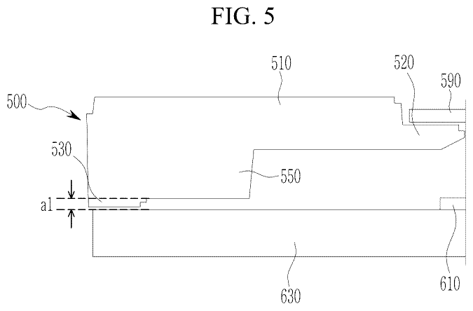

FIG. 5 shows a cross-sectional view of a portion of a sub-housing of FIG. 4 received on a first substrate.

Referring to FIG. 5, the protrusion 550 may be spaced apart from the first substrate by a predetermined distance a1. The protrusion 550 may suppress the bending of the substrate. That is, when the first substrate 630 receives a force and is bent in the direction of the sub-housing, the protrusion 550 may function as a stopper to prevent a side portion of the first substrate 630 from going higher than the distance a1. Hence, an entire bending degree of the first substrate 630 may be suppressed. When the bending degree of the first substrate 630 is suppressed, the bending of the image sensor arranged on the first substrate 630 may be suppressed.

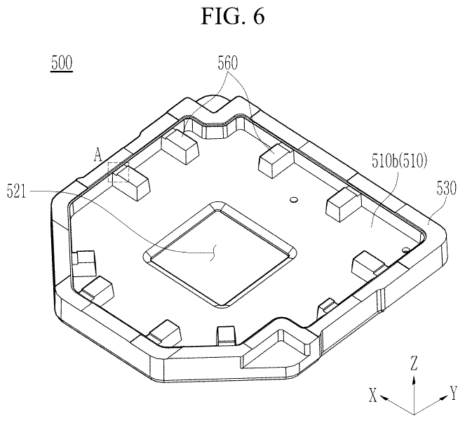

A sub-housing of a camera module according to another embodiment will now be described with reference to FIG. 6 to FIG. 8.

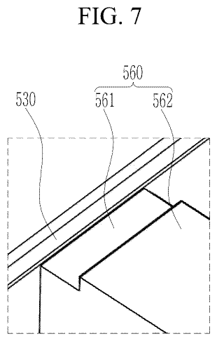

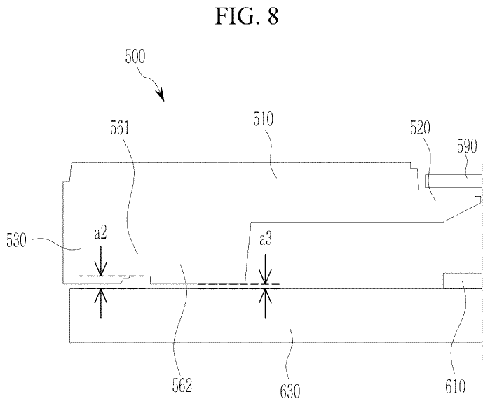

FIG. 6 shows a rear surface of a sub-housing according to another embodiment. FIG. 7 shows a portion A of FIG. 6. FIG. 8 shows a portion of a sub-housing of FIG. 6 received on a first substrate. The sub-housing according to the present embodiment is similar to the sub-housing described with reference to FIG. 2 to FIG. 7. The same parts will not be repeatedly described.

Referring to FIG. 6 and FIG. 7, a protrusion 560 may have a step. Regarding the step of the protrusion 560, a portion disposed near the external side of the main frame 510 may be formed to be relatively lower. In other words, the step of the protrusion 560, which is near the external side of the main frame 510 may be further distant from the first substrate 630. Regarding the step of the protrusion 560, a portion directly connected to the base portion 530, that is, a portion disposed near the base portion 530 may be further distant from the first substrate 630.

Referring to FIG. 8, the protrusion 560 includes a first portion 561 that has a relatively greater gap with the first substrate 630 and a second portion 562 that has a relatively less gap with the first substrate 630 than the first portion 561. That is, the first portion 561 has a step in an opposite direction to the direction of the substrate with respect to the second portion 562. In an example, the step may have an uneven or irregular rise where the risers of the step are of different heights. The first portion 561 is disposed between the second portion 562 and the base portion 530. The first portion 561 directly contacts the base portion 530, and the second portion 562 directly contacts the first portion 561. The first portion 561 may extend to the inside from the base portion 530, and the second portion 562 may extend to the inside from the first portion 561. That is, the first portion 561 may be disposed nearer the external side of the sub-housing 500 than the second portion 562. The first portion 561 may be combined with the base portion 530 from the internal direction of the main frame 510. Therefore, the protrusion 560 is disposed in the inside than the base portion 530. The first portion 561 represents a portion where a mold is arranged when the protrusion 560 is formed. That is, the protrusion 560 may be formed by the first portion 561. As the mold is arranged on the first portion 561 and the protrusion 560 is formed, the second portion 562 may be formed nearer the first substrate 630. Curves may be formed on the first portion 561 according to the shape of the mold. A first gap a2 may be formed between the first portion 561 and the first substrate 630. For example, the first gap a2 may be equal to or greater than 0.09 mm. A second gap a3 may be formed between the second portion 562 and the first substrate 630. The first gap a2 is greater than the second gap a3. For example, the first gap a2 may be equal to or less than 0.02 mm. The second portion 562 does not contact the first substrate 630. A length of the second portion 562 measured in a planar direction, that is, the direction parallel to the main frame 510. As the second portion 562 becomes longer, the bending of the first substrate 630 may be efficiently suppressed. The length of the second portion 562 measured in the direction parallel to the main frame 510 may be greater than the length of the first portion 561. Regarding the protrusions 560, the lengths of the second portions 562 may be different from each other. That is, when the length of the second portion 562 of one protrusion 560 is compared with the length of the second portion 562 of another protrusion 560, the lengths may be different from each other. The length of the first portion 561 measured in the planar direction may depend on a size of the mold. For example, the length of the first portion 561 may be equal to or greater than 0.15 mm.

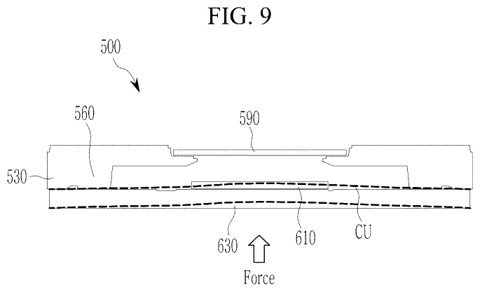

FIG. 9 shows an effect of suppressing the bending of a substrate according to the present embodiment.

Dotted lines (CU) show that the first substrate 630 is bent. When a force is applied to the first substrate 630 from the bottom, the first substrate 630 may be bent upward as marked with the dotted lines. Although not shown, the image sensor 610 mounted on the first substrate 630 may be bent upward. When the image sensor 610 is bent further than an allowable reference, a defect may be generated. The second portion 562 of the protrusion 560 functions as a stopper for bending the first substrate 630. That is, regarding the protrusion 560, as the second portion 562 is disposed nearer the first substrate so when pressure is applied to the lower portion of the first substrate 630 and the first substrate 630 is bent upward, bending of the first substrate 630 may be further suppressed by the second portion 562.

The present disclosure attempts to provide a camera module to which a sub-housing is applied to improve a bending phenomenon of a circuit board.

According to at least one of the embodiments, the protruding structure is formed on the rear surface of the sub-housing, thereby suppressing the bending of the substrate, and preventing the image sensor from being bent.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
an optical filter;
a substrate on which an image sensor is mounted; and
a sub-housing, in which the optical filter is disposed, comprising a main frame, a base portion extending toward the substrate from the main frame and contacting the substrate, and a protrusion protruding from the base portion,
wherein the protrusion comprises a first portion protruding toward an inner side of the sub-housing from the base portion and having a height forming a first gap from the substrate, and a second portion protruding toward the inner side of the sub-housing from the first portion and having another height forming a second gap from the substrate that is narrower than the first gap.

2. The camera module of claim 1, wherein
the protrusion is spaced apart from the substrate.

3. The camera module of claim 1, wherein
the protrusion extends toward a hollow space of the sub-housing from the base portion.

4. The camera module of claim 1, wherein
the second gap is equal to or less than 0.02 mm.

5. The camera module of claim 1, wherein
the first gap is equal to or greater than 0.09 mm.

6. The camera module of claim 1, wherein
the protrusion comprises at least two protrusions.

7. The camera module of claim 1, wherein
the second portion is longer than the first portion.

8. A camera module comprising:
an optical filter;
a substrate on which an image sensor is mounted; and
a sub-housing, accommodating the optical filter, comprising a main frame, a base portion extending toward the substrate from the main frame and contacting the substrate, and a protrusion protruding from the base portion,
wherein the protrusion comprises a step portion with an uneven rise protruding toward an inner side of the sub-housing from the base portion.

9. The camera module of claim 8, wherein the protrusion is spaced apart from the substrate.

10. The camera module of claim 8, wherein the protrusion comprises a first portion protruding toward the inner side of the sub-housing from the base portion and having a height forming a first gap from the substrate, and a second portion protruding toward the inner side of the sub-housing from the first portion and having another height forming a second gap from the substrate that is narrower than the first gap.

11. The camera module of claim 10, wherein the second gap is equal to or less than 0.02 mm.

12. The camera module of claim 10, wherein the first gap is equal to or greater than 0.09 mm.
